(19) United States
(12) Patent Application Publication
(10) Pub. No.: US 2018/0313136 A1
(43) Pub. Date: Nov. 1, 2018

(54) COMPOSITE PROFILE, AND METHOD FOR PRODUCING THE COMPOSITE PROFILE

(71) Applicant: Welser Profile Austria GmbH, Ybbsitz (AT)

(72) Inventors: Kurt Aigner, Ybbsitz (AT); Bernd Schmitte, Muenster (DE)

(73) Assignee: Welser Profile Austria GmbH, Ybbsitz (AT)

(21) Appl. No.: 15/964,240

(22) Filed: Apr. 27, 2018

(30) Foreign Application Priority Data
Apr. 28, 2017 (EP) 17168701

(51) Int. Cl. E06B 3/263; E06B 3/273

(52) U.S. Cl. CPC E06B 3/26307; E06B 2003/26376; E06B 2003/26396; E06B 3/273

(57) ABSTRACT

A composite profile for windows, fixed glazing, façades, doors or glass roofs. A metal profile is produced by shaping, in particular by roll-forming, from a sheet metal material and that has a profile cross section that forms a groove and a web, the web being formed by profile portions that are on top of one another at least in portions and transition into profile portions that define the groove. The composite profile further comprises an integral or multi-part insulating profile received in the groove of the metal profile in portions and is non-positively and/or positively connected to the metal profile. The insulating profile and/or a further profile received in the groove of the metal profile engages/engage in pockets of the metal profile that are open towards the groove and are arranged on either side of the web.

The invention relates to a composite profile having the features of the preamble of claim 1. The composite profile can be used in the construction field as a profile member for a window, door or façade, and is accordingly suitable in particular for producing windows, fixed glazing, doors or glass roofs. For this purpose, said composite profile comprises at least one metal profile and an insulating profile that is non-positively and/or positively connected to the metal profile.

The invention further relates to a method for producing a composite profile of this kind.

### PRIOR ART

Composite profiles of the type mentioned above are well known from the prior art. The insulating or insulator profile produces thermal separation between the metal profile and a further metal profile and/or a sub-structure, such that a thermal bridge is not formed. For this purpose, the insulating or insulator profile is manufactured from a material that has a significantly lower thermal conductivity than metal. Plastics material is generally used as the material.

In order for the composite profile to be able to support high loads, a stable bond between the at least one metal profile and the insulating or insulator profile must be ensured. It is furthermore necessary to ensure that the bond is stable throughout the entire service life. For this purpose, the metal profile and the insulating or insulator profile are connected in a non-positive and/or positive manner.

EP 2 476 853 A1 discloses, by way of example, a method for producing a composite profile for windows, fixed glazing, façades, doors or glazed roofs, in which a non-positive and/or positive connection is established between a metal profile and an insulating profile by means of plastically deforming at least one profile portion of the metal profile. The profile portion is a lateral boundary of a fastening groove into which the insulating profile is inserted. The desired non-positive and/or positive connection between the metal profile and the insulating profile is established by roller-forming the profile portion onto the insulating profile. However, a stable bond is ensured only when the amount to which the profile portion resiliently springs back after the roller-forming is kept within strict limits. In addition, there must be sufficient rigidity to prevent the fastening groove from bending up when loaded. Therefore, in EP 2 476 853 A1, profile portions of the metal profile that adjoin the profile portions defining the groove and are adjacent to one another are interconnected in the region of their mutual border. In particular, an integral connection by means of laser welding, roll welding, soldering or adhesive bonding is proposed, since these connection methods make it possible to achieve a connection of the profile portions that is not visible from the outside, with the result that smooth visible surfaces of the finished composite profile are maintained.

Proceeding from the prior art mentioned above, the object of the present invention is that of specifying a composite profile, comprising a metal profile and an insulating profile, that has a high degree of inherent rigidity and is also as simple and cost-effective as possible to produce.

In order to achieve the object, the composite profile having the features of claim 1, and the method having the features of claim 14, are proposed. Advantageous developments of the invention can be found in the dependent claims in each case.

### DISCLOSURE OF THE INVENTION

The proposed composite profile comprises a metal profile that is produced by means of shaping, in particular by roll-forming, from a sheet metal material and that has a profile cross section that forms a groove and a web. In this case, the web is formed by profile portions that are on top of one another at least in portions and transition into profile portions that define the groove. The proposed composite profile further comprises an integral or multi-part insulating profile that is received in the groove of the metal profile in portions and is non-positively and/or positively connected to the metal profile. According to the invention, the insulating profile and/or a further profile received in the groove of the metal profile engages/engage in pockets of the metal profile that are open towards the groove and are arranged on either side of the web. In this way, the insulating profile and/or the further profile produces a clamping effect that extends across the web and counteracts upward bending, when loaded, of the groove that receives the insulating profile and/or the further profile. Complex additional measures intended to prevent upward bending of the groove of the metal profile can thus be omitted. In particular, an integral connection of the profile portions that form the web and adjoin the profile portions defining the groove is not required.

The clamp action of the insulating profile and/or of a further profile received in the groove accordingly achieves an increased inherent rigidity of the composite profile using simple means, which promotes a permanently stable bond.

If the insulating profile itself assumes the function of a clamp, an increased inherent stiffness can be achieved simply by inserting the insulating profile into the groove of the metal profile, and at the latest when the profile portions defining the groove are shaped in order to establish the non-positive and/or positive connection between the insulating profile and the metal profile.

If, alternatively or in addition, the clamp function is assumed by at least one further profile received in the groove, the at least one further profile can be inserted into the groove alone or together with the insulating profile. The latter case requires the at least one further profile to first be connected to the insulating profile, if a connection does not already exist. The connection can be implemented by a simple insertion, clamping and/or latching connection for example. The further profile preferably has a profile cross section in the shape of a clamp or a bracket in order to simplify the connection of the further profile to the metal profile and/or to the insulating profile.

The insulating profile of a composite profile according to the invention may be connected or connectable not only to just one further profile, but also to a plurality of further profiles or profile sections. The plurality of profiles or profile sections are preferably arranged in each case so as to be mutually spaced one behind the other and/or side-by-side. Arranging a plurality of profiles or profile sections of this kind one behind the other requires said profiles or profile sections to be shorter, in the profile longitudinal direction, than the insulating profile.

In order to achieve the desired clamp action, the pockets formed in the metal profile must be of a sufficient depth. In this case the depth is preferably measured in parallel with a central longitudinal axis A of the metal profile, which axis in turn preferably extends centrally with respect to the groove and/or the web of the metal profile. That is to say that the pockets preferably extend substantially in parallel with the central longitudinal axis A of the metal profile. Advantageously, the depth of the pockets is selected so as to be at least equal to or greater than the width of the pockets in the transition to the groove, such that sufficient interlocking of the insulating profile and/or of the further profile with the metal profile is ensured.

Alternatively or in addition, the lateral boundaries of the pockets are mutually parallel at least in portions, such that the insulating profile and/or further profile engaging therein is optimally supported by the parallel planar surfaces. It is also preferable for the parallel portions of the lateral boundaries of the pockets to be oriented in parallel with respect to the web and/or to the profile portions forming the web, in order to achieve the desired clamp effect.

The groove of the metal profile that receives the insulating profile and/or the further profile comprises a groove base and an opening, the opening preferably being opposite the groove base. In this case, the pockets that are open towards the groove and in which the insulating profile and/or the further profile inserted into the groove engages/engage, can be arranged in the region of the groove base and/or in the region of the opening of the groove. The advantage of pockets arranged in the region of the groove base is that the desired clamp effect can be achieved simply by inserting the insulating profile and/or the further profile into the groove of the metal profile.

The insulating profile and/or the further profile preferably has/have a profile cross section that forms a clamping lug. A positive connection of the insulating profile and/or the further profile to the metal profile can be achieved in a simple manner by means of the preformed clamping lugs, since, when the relevant profile is inserted into the groove of the metal profile for example, the clamping lugs only need to be engaged with the pockets of the metal profile. Since the metal profile has pockets arranged on either side of the web, i.e. at least two pockets, the clamping lugs formed on the insulating profile and/or on the further profile furthermore form at least one clamping lug pair which can be engaged in the pockets arranged on either side of the web. In order to optimise the positive connection brought about by the clamping lugs, the cross-sectional shape of the clamping lugs is preferably matched to the cross-sectional shape of the pockets.

The clamping lugs of the insulating profile and/or of the further profile preferably form clamping webs that extend in the longitudinal direction of the profile. It is also preferable for the pockets of the metal profile to form longitudinal grooves that extend in the longitudinal direction of the profile. In this way, a clamp action can be achieved over a partial length or over the entire length of the composite profile.

The proposed clamping lugs and/or pockets are preferably formed immediately, at the same time that the profile in question is produced, such that the measures required for achieving the desired clamp effect can be implemented in as cost-neutral a manner as possible.

Advantageously, the insulating profile of the proposed composite profile is manufactured from plastics material at least in portions or in part. Plastics material has a significantly lower thermal conductivity than metal, and therefore thermal separation can be achieved by the insulating profile. The thermal separation prevents the formation of a thermal bridge, for example when the metal profile is connected, by means of the insulating profile, to a further metal profile.

In a development of the invention, the insulating profile is manufactured from at least two different materials, in particular two different plastics materials. For example, one portion or one part of the insulating profile may be manufactured from a material that as an increased strength compared with a basic material of the insulating profile. Said portion or part of the insulating profile is preferably engaged with the pockets formed in the metal profile in order to increase the inherent rigidity in the region of the positive connection. That is to say that in particular a portion of the insulating profile that forms a clamping lug, or a part of the insulating profile that forms a clamping lug, is manufactured from a material having increased strength. However, moreover, a reduced strength of the clamping lugs or of a portion or part of the insulating profile that forms clamping lugs may also be desired in order, for example, to allow for plastic deformation of the clamping lugs when said lugs are inserted into the pockets and/or when the positive connection is established between the insulating profile and the metal profile. The plastic deformation of the clamping lugs can then ensure that the clamping lugs engage sufficiently deeply into the pockets and/or fill the pockets as completely as possible.

Alternatively or in addition to using different materials, it is possible for the insulating profile to be connected to at least one further profile or to the further profile, the at least one further profile or the further profile preferably being manufactured from a different material from that of the insulating profile. The at least one further profile may be manufactured from another plastics material or from metal for example. The advantage of using a metal material is that said material generally has a high strength, and is therefore suitable in particular for forming particularly dimensionally stable clamping lugs. In addition, particularly small clamping lug cross sections can be achieved when a metal material is used.

The insulating profile and the at least one further profile can be connected in a non-positive, positive and/or integral manner. An integral connection can for example be achieved by the further profile also being inserted into the mould during production of the insulating profile.

Furthermore, the at least one further profile has a substantially U-shaped profile cross section. The U-shape facilitates a connection between the further profile and the insulating profile, since the further profile can be oriented such that the lateral limbs of the U-shaped further profile surround the insulating profile at the end thereof. Projections may in addition be formed on the inner faces of the lateral limbs, which projections engage in the insulating profile such that a positive connection is achieved in addition. Alternatively or in addition, the lateral limbs may be formed as spring arms, such that a positive connection can also be achieved by subsequently pushing the further profile onto an end portion of the insulating profile. Projections may again be formed on the free ends of the spring arms, by means of which projections a positive connection to the insulating profile can be established.

The U-shaped profile cross section of the further profile can also be used to form clamping lugs. For this purpose, the further profile is oriented such that the free ends of the lateral limbs point towards the pockets. Angled spring arms can in addition be formed on the free ends of the lateral limbs, such that the lateral limbs can be brought into clamping engagement with the pockets of the metal profile.

Furthermore, the further profile may comprise lateral limbs that each have free ends at either end thereof, such that both clamping lugs and limbs for connecting to the insulating profile can be formed.

The further profile connected to the insulating profile can also be formed as a simple wire. The wire may have a circular, oval or angular cross section. In order to be connected to the insulating profile, the wire can also be inserted into the mould during production of the insulating profile. If the cross section of the wire is suitable only for forming a single clamping lug, the insulating profile can also be connected to two profiles of the same cross section, such that the two profiles together form a clamping lug pair.

In order to optimise the positive connection between the insulating profile and the metal profile, the wire or the wires may be manufactured from a material that allows some degree of plastic deformation while the profile portions of the metal profile that define the groove are being roller-formed onto the insulating profile, such that the wires are pushed into the pockets of the metal profile arranged on either side of the web. A relatively soft metal, such as aluminium or an aluminium alloy, is therefore particularly suitable as the material for the wires.

The pockets of the metal profile that are open towards the groove are preferably produced by shaping, in particular by roll-forming, the profile portions defining the groove. That is to say that the pockets can formed immediately, at the same time that the metal profile is produced.

The profile portions of the metal profile that define the groove preferably each comprise a crimping or bead at the end thereof, which crimping or bead engages behind an outer contour of the insulating profile. The crimpings or beads can increase the inherent rigidity of the profile portions defining the groove, in particular in the region of the opening of the groove. Since the crimpings or beads engage behind an outer contour of the insulating profile, a positive connection is in addition achieved, which connection counteracts a relative movement of the insulating profile with respect to the metal profile, in a direction perpendicular to the longitudinal direction of the profile. A further advantage of the bead is that it forms a pocket suitable for receiving a clamping lug, which pocket is arranged in the region of the opening of the groove. A clamping lug of the insulating profile preferably engages in said pocket.

It is also preferable for the profile portions of the metal profile defining the groove to be compressed in regions. The compressing can be carried out during shaping, in particular roll-forming, of the sheet metal material in order to produce the metal profile. The compressing leads to locally changed sheet metal thicknesses, it being possible for the sheet metal material to be displaced such that sharp-edged inner contours are formed in the region of a bend in the sheet metal and/or in the region of a pocket. That is to say that shaping, in particular roll-forming, also makes it possible to produce pockets having a rectangular cross-sectional shape. If a pocket adjoins a bend in the sheet metal having a sharp-edged inner contour, the pocket can be widened, since the bend in the sheet metal requires less space.

The profile portions defining the groove are preferably compressed in the region of the groove base, since there is little space here for forming pockets on account of multiple bends in the sheet metal material.

In cross section, the pockets preferably have a width b of at least 0.2 mm. That is to say that the width does not fall below a minimum width of 0.2 mm over the entire depth of a pocket. It is also preferable for the width b to be at least 0.4 mm, such that correspondingly wide clamping lugs can be engaged in the pockets. The width of a pocket can increase towards the groove, the lateral boundaries of a pocket preferably extending in parallel at least in portions, however, in order to achieve an optimal positive connection of the insulating profile and/or the further profile to the metal profile.

The groove of the metal profile is preferably symmetrical in cross section. That is to say that the profile portions defining the groove are deformed in a uniform manner when the profile portions defining the groove are roller-formed onto the insulating profile in order to establish the non-positive and/or positive connection to the metal profile. The process is therefore easier to control. For this purpose, the groove may have a cross-sectional shape that is substantially triangular, trapezoidal, rectangular and/or that is circular at least in portions. In the case of a substantially triangular or trapezoidal cross-sectional shape, the groove preferably widens towards the opening thereof in order to facilitate the insertion of the insulating profile into the groove. Since the profile portions defining the groove are plastically deformed during roller-forming, a groove initially having a trapezoidal cross section may have a rectangular cross-sectional shape after roller-forming.

It is also preferable for the web of the metal profile to be arranged centrally with respect to the groove. In this way, symmetry of the profile cross section of the metal profile is achieved, which symmetry facilitates the formation of the pockets arranged on either side of the web. In this case, the central longitudinal axis A of the metal profile extends centrally with respect to the groove and centrally with respect to the web.

In a development of the invention, the profile portions forming the web are connected by further profile portions. In this case, the further profile portions form a profile loop which makes it possible to produce the metal profile from a sheet metal strip which is preferably shaped for this purpose such that the free ends of the sheet metal strip form the groove.

The further profile portions or the profile portions of the profile loop preferably form at least one flange. The flange contributes to increasing the inherent rigidity of the composite profile. Furthermore, the flange can be used for attaching a glass element, a panel, a seal and/or a further profile. It is also preferable for the flange to be oriented substantially perpendicularly with respect to the web, so as to form a planar contact surface for a glass element, a panel, a seal and/or a further profile. For example, the metal profile of the proposed composite profile may have a substantially T-shaped or L-shaped profile cross section. Moreover, a plurality of further cross-sectional shapes can also be achieved, which shapes may be both symmetrical and asymmetrical with respect to the central longitudinal axis A.

The profile portions of the profile loop may rest on top of one another at least in regions. Doubling of the sheet metal in this way can further increase the inherent rigidity of the metal profile and thus of the composite profile. Alternatively or in addition, individual profile portions of the profile loop may surround a cavity or a chamber, with the result that the metal profile is formed as a hollow profile at least in portions. This further increases the inherent rigidity of the metal profile.

In order to achieve the object mentioned at the outset, a method for producing a composite profile according to the invention is furthermore proposed. The method comprises the steps of:

a) providing a metal profile that has been produced by means of shaping, in particular by roll-forming, from a sheet metal material and that has a profile cross section that forms a groove and a web, the web being formed by profile portions that are on top of one another at least in portions and transition into profile portions that define the groove,

b) providing an integral or multi-part insulating profile which is inserted into the groove of the metal profile in portions and is non-positively and/or positively connected to the metal profile.

According to the invention, the insulating profile and/or a further profile that is inserted into the groove of the metal profile before or together with the insulating profile is/are brought into engagement with pockets of the metal profile that are open towards the groove and that are arranged on either side of the web. In this way, a clamp effect is achieved by the insulating profile and/or further profile, which effect counteracts upward bending of the groove, since the profile portions of the metal profile that form the web are held together by the insulating profile and/or further profile engaged in the pockets arranged on either side.

The pockets have preferably been formed by shaping, in particular roll-forming, during production of the metal profile, such that no secondary machining of the metal profile is required in order to produce the pockets. In order to create pockets having a substantially rectangular inner contour, the sheet metal material can be compressed in regions, in particular in the region of a groove base of the groove, during shaping or roll-forming.

Furthermore, in order to non-positively and/or positively connect the insulating profile to the metal profile, the profile portions of the metal profile that define the groove are plastically deformed, preferably by means of roller-forming onto the insulating profile. The plastic deformation of the profile portions that define the groove can be used in particular to establish a positive connection. For this purpose, the insulating profile preferably has an outer contour that can be surrounded by the profile portions defining the groove. The plastic deformation of the profile portions defining the groove when establishing the non-positive and/or positive connection between the insulating profile and the metal profile can also be used for forming pockets. This is the case in particular for forming pockets that are arranged in the region of the opening of the groove. For example, the ends of the profile portions defining the groove can each be provided with a bead, as a result of which pockets are formed in the region of the opening of the groove.

In order to bring the insulating profile and/or the further profile into engagement with the pockets of the metal profile, said profiles preferably form clamping lugs. The clamping lugs are preferably brought into engagement with said pockets when the insulating profile and/or the further profile is inserted into the groove of the metal profile. Alternatively or in addition, clamping lugs formed on the insulating profile and/or on the further profile can be brought into engagement with the pockets of the metal profile when establishing the non-positive and/or positive connection between the insulating profile and the metal profile.

The clamping lugs can in particular be designed so as to completely fill the pockets. For this purpose, the cross-sectional shape of the clamping lugs is matched to the cross-sectional shape of the pockets. Moreover, clamping lugs may be provided which are formed by angled spring arms of a profile and can be brought into clamping engagement with the pockets.

Furthermore, when establishing the non-positive and/or positive connection between the insulating profile and the metal profile, the insulating profile and/or the further profile is/are plastically deformed, at least in regions, preferably in the region of the clamping lugs engaged with the pockets. Plastic deformation of the clamping lugs can further optimise the positive connection that produces the clamp effect.

The sheet metal material from which the metal profile of the composite profile is produced preferably has a sheet thickness of 1-3 mm, more preferably 1-2 mm. The sheet thickness may be 1.5 mm for example. The sheet metal material may in particular be a sheet steel, since said material promotes high inherent rigidity of the composite profile.

Preferred embodiments of the invention will be described in greater detail in the following, with reference to the accompanying drawings, in which:

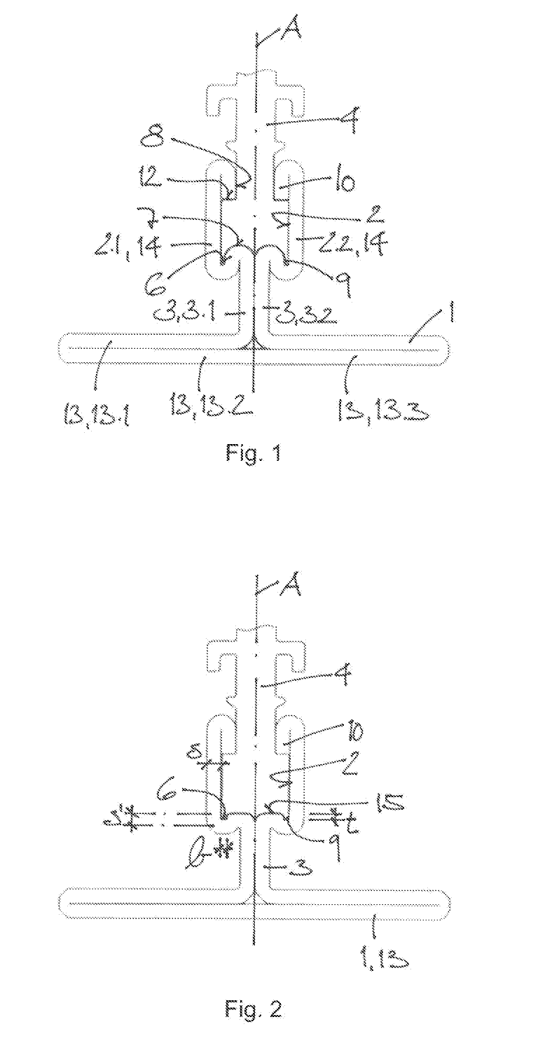

FIG. 1 is a cross section through a first preferred embodiment of a composite profile according to the invention,

FIG. 2 is a cross section through a second preferred embodiment of a composite profile according to the invention,

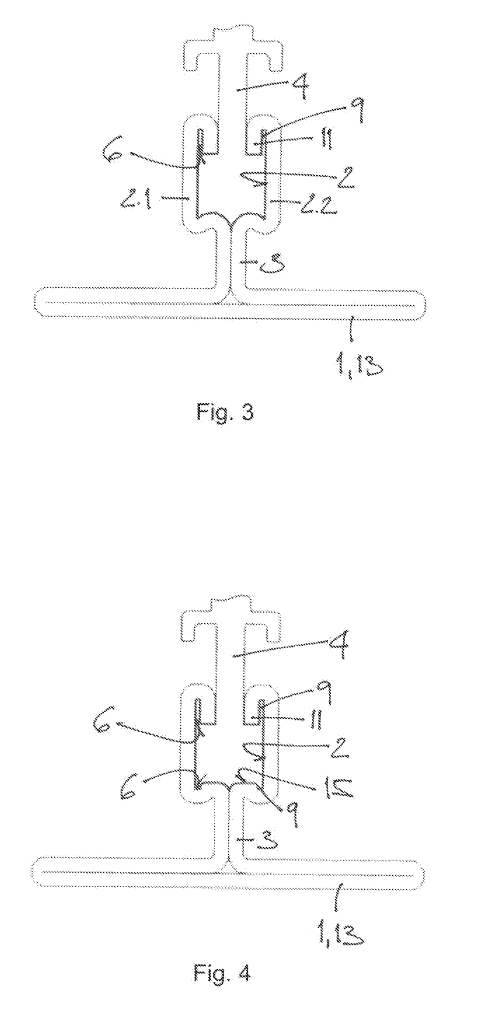

FIG. 3 is a cross section through a third preferred embodiment of a composite profile according to the invention,

FIG. 4 is a cross section through a fourth preferred embodiment of a composite profile according to the invention,

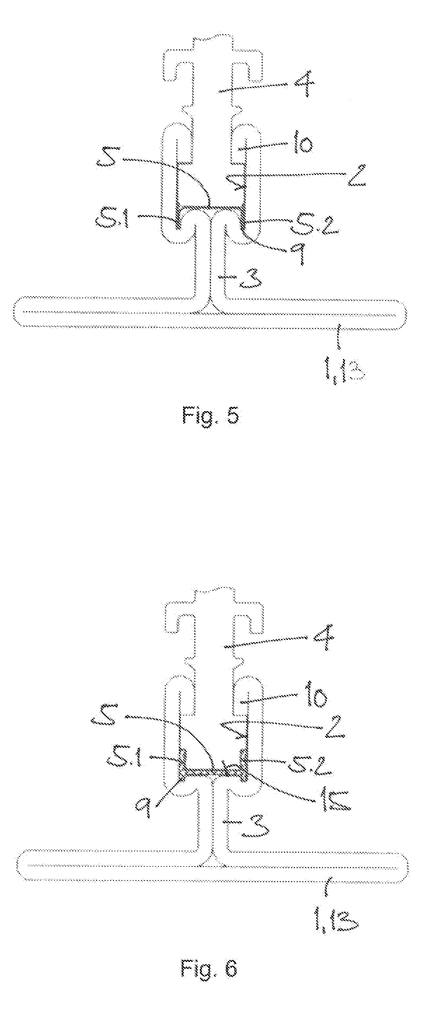

FIG. 5 is a cross section through a fifth preferred embodiment of a composite profile according to the invention,

FIG. 6 is a cross section through a sixth preferred embodiment of a composite profile according to the invention,

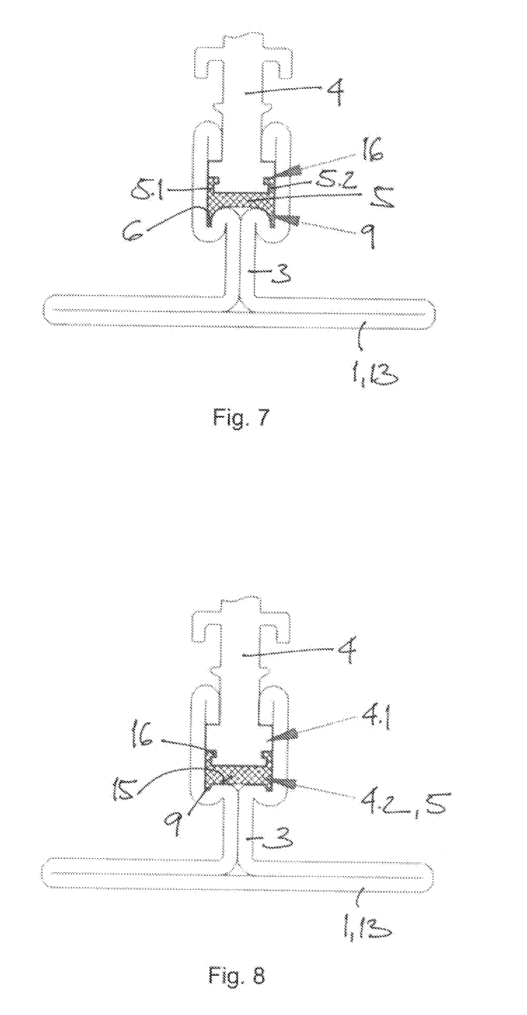

FIG. 7 is a cross section through a seventh preferred embodiment of a composite profile according to the invention,

FIG. 8 is a cross section through an eighth preferred embodiment of a composite profile according to the invention,

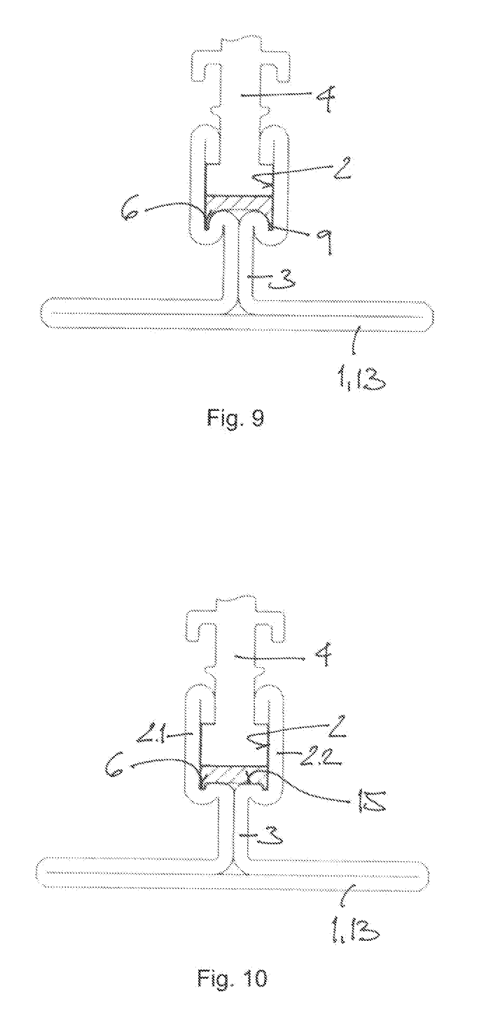

FIG. 9 is a cross section through a ninth preferred embodiment of a composite profile according to the invention,

FIG. 10 is a cross section through a tenth preferred embodiment of a composite profile according to the invention,

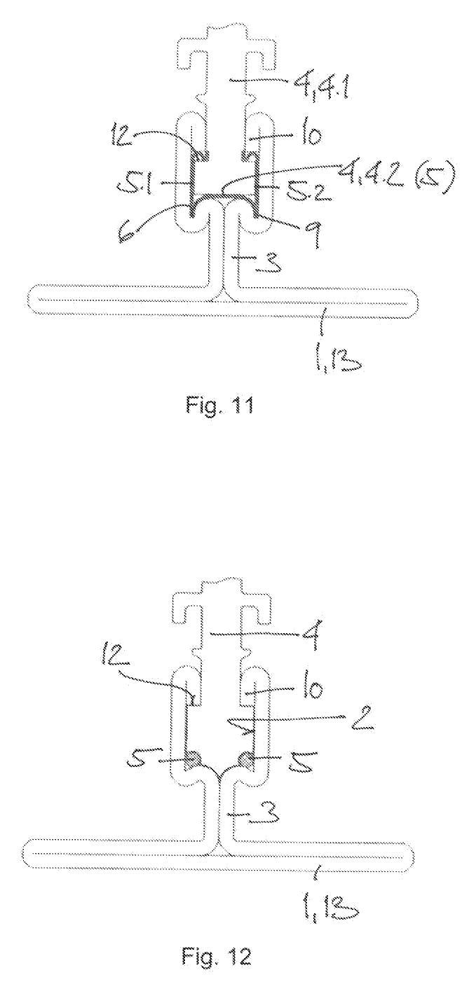

FIG. 11 is a cross section through an eleventh preferred embodiment of a composite profile according to the invention,

FIG. 12 is a cross section through a twelfth preferred embodiment of a composite profile according to the invention,

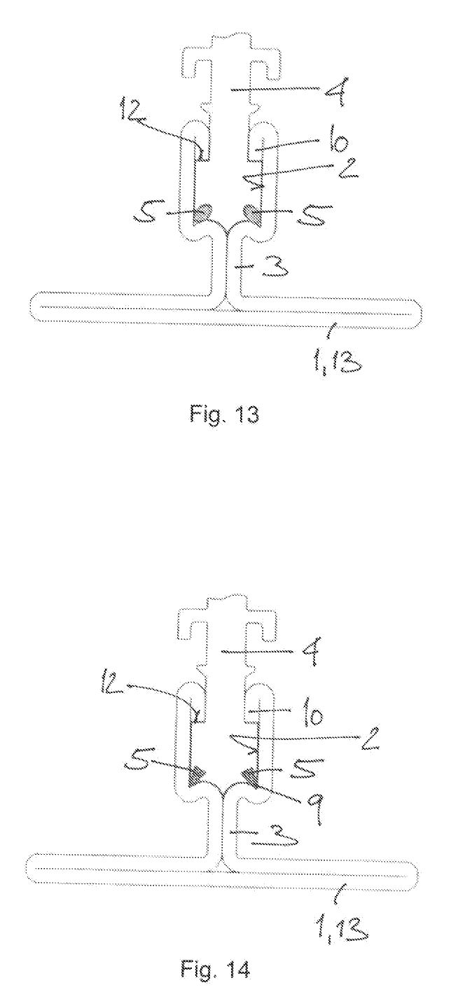

FIG. 13 is a cross section through a thirteenth preferred embodiment of a composite profile according to the invention,

FIG. 14 is a cross section through a fourteenth preferred embodiment of a composite profile according to the invention, and

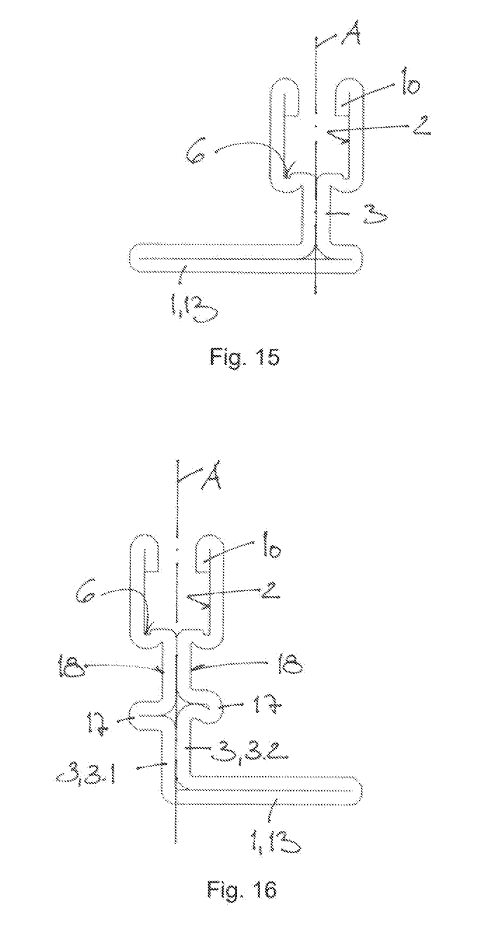

FIG. 15-18 are each a cross section through a metal profile for a composite profile according to the invention in different embodiments.

### DETAILED DESCRIPTION OF THE DRAWINGS

The composite profile shown in cross section in FIG. 1 comprises a metal profile 1 that has been produced from sheet metal, by means of shaping, and has a substantially T-shaped profile cross section. The metal profile 1 forms a groove 2 that is defined by profile portions 2.1, 2.2. An end portion of an insulating profile 4 is received in the groove 2 such that the profile portions 2.1, 2.2 of the metal profile 1 that define the groove 2 surround the end portion. In addition, crimpings 10 formed on the ends of the profile portions 2.1, 2.2 achieve a positive connection, since said crimpings each engage behind an outer contour 12 of the insulating profile 4.

A web 3 adjoins the groove 2 of the metal profile 1, which web is formed by the profile portions 3.1, 3.2. Said profile portions are connected by further profile portions 13.1, 13.2, 13.3 such that a flange 13 is formed. The profile portions rest against one another in a planar manner in the region of the web 3 and of the flange 13, such that an increased inherent rigidity is achieved by the doubling of the sheet metal. The metal profile 1 can also be formed from a sheet metal strip in this manner.

The profile portions 2.1, 2.2 defining the groove 2 are shaped multiple times, so as to form a groove base 7 and lateral boundaries 14 that end in the crimpings 10 and thus define an opening 8 of the groove 2. In order to counteract upward bending of the groove 2, the profile portions 2.1, 2.2 defining the groove form pockets 6 in the region of the groove base 7, in which pockets clamping lugs 9 of the insulating profile 4 engage. Since a pocket 6 is arranged on either side of the web 3 in each case, the clamping lugs 9 of the insulating profile 4 that are engaged with the pockets 6 produce a clamp effect that extends across the web and holds together, when loaded, the profile portions 3.1, 3.2 that form the web 3.

Two clamping lugs 9 are provided in FIG. 1, which lugs are formed by the insulating profile 4 itself. In this case, the insulating profile 4 is manufactured from one material throughout. In order to achieve an optimal clamp effect, the clamping lugs 9 have a minimum width which is specified by a minimum width b of the pockets 6 (see also FIG. 2). In FIG. 1, the width b is 0.4 mm. In order to facilitate the insertion of the clamping lugs 9 into the pockets 6, the pockets 6 widen towards the groove 2.

FIG. 2 shows a modification of the composite profile of FIG. 1. The profile portions 2.1, 2.2 that define the groove comprise a flattening 15 in the region of the groove base 7, specifically adjacently to a pocket 6 in each case. This is the result of the sheet metal thickness being reduced and the sheet metal material simultaneously being compressed. While the profile portions 2.1, 2.2 have a sheet thickness s of 1.5 mm in the region of the lateral boundaries 14, the sheet thickness s′ in the region of the reduction in the sheet metal thickness is approximately 1-1.2 mm. By forming the flattenings 15, a part of the sheet metal material is simultaneously displaced towards the pockets 6, with the result that said pockets have a rectangular cross-sectional shape. At the same time, the width b of the pockets 6 could be increased so as to be 0.5 mm. Since the rectangular cross-sectional shape of the pockets 6 can bring about optimal support of the insulating profile 2, the depth t of the pockets 6 can be smaller. In this case, the depth t is selected so as to be equal to the width b.

A further modification of a composite profile according to the invention can be seen in FIG. 3. In this embodiment, the clamping lugs 9 and the pockets 6 are not arranged in the region of the groove base 7, but instead in the region of the opening 8 of the groove 2. In order to form the pockets 6, the ends of the profile portions 2.1, 2.2 defining the groove do not comprise a crimping 10, but instead beads 11. The clamping lugs 9 arranged in the region of the opening 8 not only counteract upward bending of the groove 2 when loaded, but furthermore prevent the profile portions 2.1, 2.2 from springing back during the process of roller-forming onto the insulating profile 4.

FIG. 4 shows a combination of the embodiments of FIG. 2 and FIG. 3, since pockets 6 are formed both in the region of the groove base 7 and in the region of the opening 8 of the groove 2, in which pockets clamping lugs 9 of the insulating profile 4 engage. A maximum clamp effect is thus achieved, which effect counteracts upward bending of the groove 2 when loaded, and springing back of the profile portions 2.1, 2.2 during roller-forming.

The embodiment of FIG. 5 shows that the clamping lugs 9 do not necessarily have to be formed on the insulating profile 4. In FIG. 5, the clamping lugs 9 are formed by a further profile 5 that is manufactured from metal and is inserted into the groove 2 of the metal profile 1. The further profile 5 is formed as a U-shaped spring clip, the lateral limbs 5.1, 5.2 of which are angled at the ends thereof so as to form spring arms. The spring arms can be brought into clamping engagement with the pockets 6 of the metal profile 1. The spring arms accordingly form clamping lugs 9.

The further profile 5 inserted into the groove 2 can, as shown in FIG. 6, also be formed as an angle section having a substantially U-shaped profile cross section. In this case, the lateral limbs 5.1, 5.2 of the profile 5 not only form clamping lugs 9, but furthermore also connect the profile 5 to the insulating profile 4. The connection may have been established prior to inserting the two profiles into the groove 2, or may be established only when the insulating profile 4 is inserted. The profile 5 is in addition supported on groove-side flattenings 15 of the profile portions 2.1, 2.2 of the metal profile 1.

In the embodiment of FIG. 7, the further profile 5 is positively connected to the insulating profile 4. The positive connection is achieved by means of angled ends 16 of the lateral limbs 5.1, 5.2 which engage in the insulating profile 4. In order to establish the positive connection, the further profile 5 may have also been inserted into the of the insulating profile 4. However, the further profile 5 may also have been subsequently pushed onto the insulating profile 4. In this case, the insulating profile 4 is formed in multiple parts and comprises a first part 4.1 and a further part 4.2 that is formed by the further profile 5 (see also FIG. 8). The further profile 5 may be manufactured from metal or plastics material for example.

A modification of the embodiment from FIG. 7 can be seen in FIG. 8. In this case, the profile 5 is supported on flattenings 15 of the profile portions 2.1, 2.2 of the metal profile 1 that define the groove 2. The clamping lugs 9 formed on the profile 5 have a rectangular cross section, in accordance with the pockets 6.

In the embodiments in FIGS. 9 and 10, the clamping lugs 9 are formed by the insulating profile 4 which, in this case, is manufactured from a different material, in particular a different plastics material. The portion forming the clamping lugs 9 can thus be coextruded. Unlike the embodiment in FIG. 9, the metal profile 1 of the composite profile of FIG. 10 comprises pockets 6 that have a rectangular cross-sectional shape. Flattenings 15 also adjoin the pockets 6. For this purpose, the profile portions 2.1, 2.2 that define the groove have been compressed in regions.

FIG. 11 again shows an insulating profile 4 formed in multiple parts, a part 4.2 being formed by a profile 5 made of metal. The profile 5 forms clamping lugs 9 which engage in pockets 6 of the metal profile 1. The clamping lugs 9 are formed by lateral limbs 5.1, 5.2 which are bent inwards at the other end in order to engage behind the outer contour 12 of a further part 4.1 of the insulating profile 4. The multiple parts 4.1, 4.2 of the insulating profile 4 can thus be positively connected. The part 4.2 can be shorter than the part 4.1 in the longitudinal direction of the profile. For example, the part 4.2 may be a short profile section. In this case, the insulating profile 4 may comprise a plurality of short profile sections of this kind which are pushed or clamped onto the part 4.1 so as to be mutually spaced.

The illustrations in FIGS. 12 to 14 show that simple wires can also be inserted into the insulating profile 4 at the same time, in order to form clamping lugs 9. In this case, each wire forms a further profile 5 that is rigidly connected to the insulating profile 4. The profile cross section of a profile 5 of this kind may for example be circular (FIG. 12), oval (FIG. 13) or angular, in particular triangular (FIG. 14). The advantage of profile cross sections that deviate from a circular shape is that it is possible to achieve optimal interlocking of the profile 5 with the insulating profile 4. The wires can also be inserted into the insulating profile 4 at the same time, as short wire pieces. In this case, the insulating profile 4 comprises a plurality of wire pieces of this kind in the longitudinal direction of the profile, which wire pieces are mutually spaced in the longitudinal direction.

If the insulating profile 4 is connected to a further profile 5 in order to form clamping lugs 9, the further profile 5 may extend over the entire length of the insulating profile 4 or may be shorter. In the latter case, the further profile 5 is preferably a profile section that is or can be connected to the insulating profile 4 together with other similarly designed profile sections.

The metal profile 1 of a composite profile according to the invention does not necessarily need to be symmetrical with respect to a central longitudinal axis A. Asymmetrical embodiments of a metal profile 1 are shown by way of example in FIG. 15 to 18.

For example, the illustration in FIG. 15 shows a metal profile 1 that has a substantially L-shaped profile cross section. For this purpose, the flange 13 is asymmetrical.

FIG. 16 shows a further metal profile 1 having a substantially L-shaped profile cross section. In this case, the profile portions 3.1, 3.2 forming the web 3 are bent multiple times in order to form small loops 17 which define grooves 18. Sealing profiles, for example, can be inserted into the grooves 18.

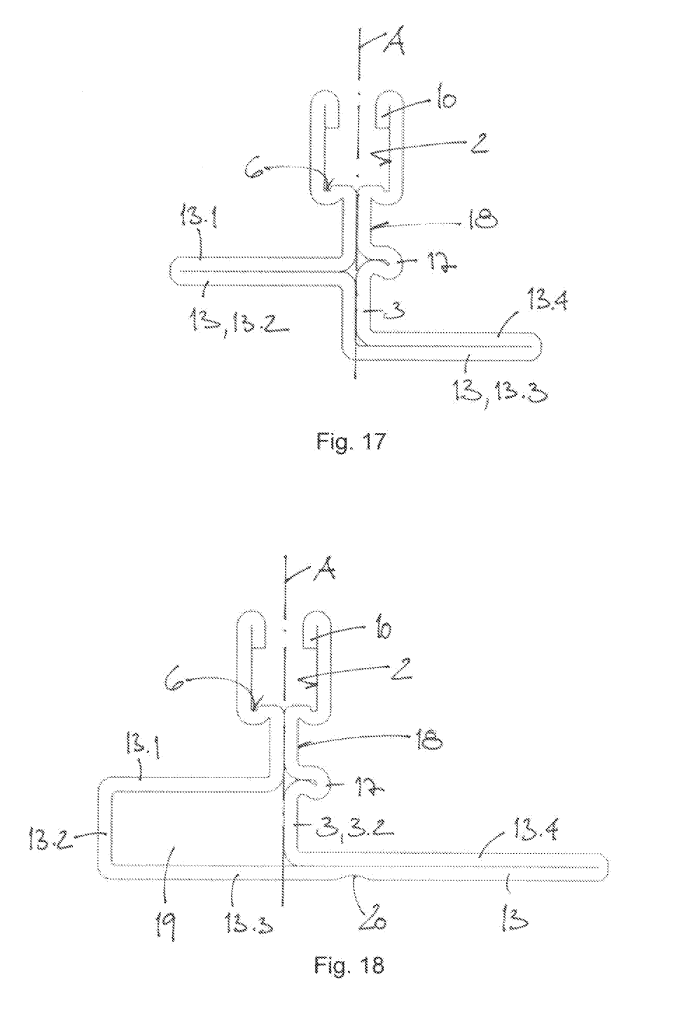

The metal profile of FIG. 17 is a combination of the metal profiles 1 from FIGS. 15 and 16. The left-hand side corresponds to the metal profile 1 of FIG. 15, and the right-hand side corresponds to the metal profile 1 of FIG. 16. This results in a flange 13 comprising mutually offset profile portions 13.1, 13.2, 13.3, 13.4. In addition, a groove 18 that is defined by a loop 17 is formed on one side, in the region of the web 3.

The metal profile 1 shown in FIG. 18 is a modification of the metal profile 1 of FIG. 17. In order to prevent an offset in the region of the flange 13, a cavity 19 is formed on the left-hand side, which cavity is surrounded by the profile portions 13.1, 13.2 and 13.3, and by the profile portion 3.2. In addition, a channel 20 is made in the centre of the profile portion 13.3, which channel provides an optical division of the front view.

### LIST OF REFERENCE SIGNS

1 metal profile

2 groove
2.1 profile portion
2.2 profile portion

3 web
3.1 profile portion
3.2 profile portion

4 insulating profile
4.1 part
4.2 part

5 profile

6 pocket

7 groove base

8 opening

9 clamping lug

10 crimping

11 bead

12 outer contour

13 flange
13.1 profile portion
13.2 profile portion
13.3 profile portion
13.4 profile portion

14 lateral boundary

15 flattening

16 end

17 loop

18 groove

19 cavity

20 channel

We claim:

1. Composite profile for windows, fixed glazing, façades, doors or glass roofs, comprising a metal profile that is produced by means of shaping, in particular by roll-forming, from a sheet metal material and that has a profile cross section that forms a groove and a web, the web being formed by profile portions that are on top of one another at least in portions and transition into profile portions that define the groove, and said composite profile further comprising an integral or multi-part insulating profile which is received in the groove of the metal profile in portions and is non-positively and/or positively connected to the metal profile,
wherein the insulating profile and/or a further profile received in the groove of the metal profile engages/engage in pockets of the metal profile that are open towards the groove and are arranged on either side of the web.

2. Composite profile according to claim 1 wherein the groove of the metal profile comprises a groove base and an opening, and the pockets that are open towards the groove are arranged in the region of the groove base and/or in the region of the opening.

3. Composite profile according to claim 1 wherein the insulating profile and/or the further profile comprises a profile cross section that forms a clamping lug, the clamping lugs preferably forming at least one clamping lug pair.

4. Composite profile according to claim 1, wherein the insulating profile is manufactured from plastics material at least in portions or in part.

5. Composite profile according to claim 1, wherein the insulating profile is manufactured from at least two different materials, in particular plastics materials, and/or is connected to the further profile (5).

6. Composite profile according to claim 1, wherein the further profile is manufactured from metal and/or has a substantially U-shaped profile cross section.

7. Composite profile according to claim 1, wherein the pockets of the metal profile have been produced by means of shaping, in particular roll-forming, the profile portions defining the groove.

8. Composite profile according to claim 1, wherein the profile portions defining the groove each comprise a crimping or a bead at the end thereof, which crimping or bead engage behind an outer contour of the insulating profile.

9. Composite profile according to claim 1, wherein the profile portions defining the groove are compressed in regions, preferably in the region of the groove base.

10. Composite profile according to claim 1, wherein the pockets each have a width (b) in cross-section that is at least 0.2 mm, preferably at least 0.4 mm.

11. Composite profile according to claim 1, wherein the groove of the metal profile is symmetrical in cross section, the groove preferably having a cross-sectional shape that is substantially triangular, trapezoidal, rectangular and/or that is circular at least in portions.

12. Composite profile according to claim 1, wherein the web of the metal profile is arranged centrally with respect to the groove.

13. Composite profile according to claim 1, wherein the profile portions forming the web are connected by further profile portions, the further profile portions preferably forming at least one flange which is in turn preferably oriented substantially perpendicularly with respect to the web.

14. Method for producing a composite profile, comprising:
a) providing a metal profile that has been produced by means of shaping, in particular by roll-forming, from a sheet metal material and that has a profile cross section that forms a groove and a web, the web being formed by profile portions that are on top of one another at least in portions and transition into profile portions that define the groove,
b) providing an integral or multi-part insulating profile which is inserted into the groove of the metal profile in portions and is non-positively and/or positively connected to the metal profile,
wherein the insulating profile and/or a further profile that is inserted into the groove before or together with the insulating profile is/are brought into engagement with pockets of the metal profile that are open towards the groove and that are arranged on either side of the web.

15. Method according to claim 14, wherein, in order to non-positively and/or positively connect the insulating profile to the metal profile, the profile portions of the metal profile that define the groove are plastically deformed, preferably by means of roller-forming onto the insulating profile.

16. Method according to claim 14, wherein clamping lugs formed on the insulating profile and/or on the further profile can be brought into engagement with the pockets of the metal profile prior to or when establishing the non-positive and/or positive connection between the insulating profile and the metal profile.

17. Method according to claim 14, wherein, when establishing the non-positive and/or positive connection between the insulating profile and the metal profile, the insulating profile and/or the further profile is/are plastically deformed, at least in regions, preferably in the region of the clamping lugs engaged with the pockets.
